(19) United States
(12) Patent Application Publication
(10) Pub. No.: US 2019/0138650 A1
(43) Pub. Date: May 9, 2019

(54) SYSTEMS AND METHODS FOR ELECTRONIC COMMUNICATION, COMMUNICATION NODE CLASSIFICATION, AND COMMUNICATION NODE AFFINITY MAPPING USING MACHINE LEARNING

(71) Applicant: Notion AI, Inc., Ann Arbor, MI (US)

(72) Inventors: Lindsay Snider, Ann Arbor, MI (US); Guy Sutter, Ann Arbor, MI (US); Ian Berry, Ann Arbor, MI (US)

(21) Appl. No.: 16/178,929

(22) Filed: Nov. 2, 2018

Related U.S. Application Data
(60) Provisional application No. 62/581,215, filed on Nov. 3, 2017.

(51) Int. Cl. G06F 17/30; G06K 9/62; G06F 15/18; H04L 12/58

(52) U.S. Cl. CPC G06F 17/30705; G06F 17/30699; G06K 9/6267; H04L 51/16; G06F 17/30867; G06F 17/30716; G06F 15/18

(57) ABSTRACT

Systems and methods enable intelligent online user classification and cohort detection within an electronic communications environment includes accessing electronic communication data exchanged between a plurality of online users; processing the electronic communication data by (i) extracting cohort data features from the electronic communication data; (ii) allowing the extracted cohort data features, as input, into a cohort grouping circuit; (iii) identifying, by the cohort grouping circuit, at least one cohort grouping comprising a subset of online users of the plurality of online users based on an output of the cohort grouping circuit; wherein the cohort grouping circuit uses the extracted cohort data features to generate a cohort network mapping that illustrates connections between the subset of online users defining the at least one cohort grouping.

### CROSS-REFERENCE TO RELATED APPLICATIONS

This application claims the benefit of U.S. Provisional Application No. 62/581,215, filed 3 Nov. 2017, which is incorporated in its entirety by this reference.

### TECHNICAL FIELD

The inventions relate generally to the electronic communication processing and electronic communication interfaces, and more specifically to new and useful electronic communication routing using affinity clusters of users operating communication nodes in the electronic communication processing and email interfaces field.

### BACKGROUND

In many modern contexts, electronic mail (email) is an often-utilized means, if not primary means, of communicating electronically. Now that e-mail communications may be composed and transmitted via numerous communication devices (e.g., mobile phones, wearable devices (e.g., watches), virtual assistive devices, etc.) other than desktops, the amount of e-mail communications received by any given recipient on a single day may easily exceed several hundred emails and probably more than one thousand emails per day. The numerous amount of emails received each day coupled with the additional responses made to some of these emails can overwhelm a user's email account or a viewing device displaying the emails. Specifically, the numerous amount of emails may often overwhelm a user's ability to digest important and/or time-sensitive emails. This, in turn, may cause the user to lose productivity, make mistakes, and/or mishandle one or more important matters.

Thus, there is a need in the electronic communication processing and electronic mail interface field to create new and useful systems and methods for improving efficiencies in email and messaging communications, reducing email and messaging communications, and preserving email and messaging computing resources. The embodiments of the present application provide such new and useful systems and methods.

### BRIEF DESCRIPTION OF THE FIGURES

FIG. 1 illustrates a system 100 in accordance with one or more embodiments of the present application;

FIG. 2 illustrates a method 200 in accordance with one or more embodiments of the present application;

FIG. 3 illustrates a schematic of a cluster of nodes in accordance with one or more embodiments of the present application; and

FIG. 4 illustrates a schematic of a network mapping of a cluster of nodes in accordance with one or more embodiments of the present application.

### SUMMARY OF THE INVENTION

In one embodiment, an online system that enables intelligent user classification and cohort detection within an electronic communications environment based on electronic communications data includes an electronic communications server that accesses electronic communication data exchanged between a plurality of online users; an electronic communication processing circuit that processes the electronic communication data by: (i) extracting cohort data features from the electronic communication data; (ii) allowing the extracted cohort data features, as input, into a cohort grouping circuit; (iii) identifying, by the cohort grouping circuit, at least one cohort grouping comprising a subset of online users of the plurality of online users based on an output of the cohort grouping circuit; wherein the cohort grouping circuit uses the extracted cohort data features to generate a cohort network mapping that illustrates connections between the subset of online users defining the at least one cohort grouping.

In one embodiment, the system includes a machine learning system comprising an ensemble of machine learning classifiers comprising a plurality of distinct machine learning classifiers, wherein each of the plurality of distinct machine learning classifiers is configured to generate a distinct classification label upon a detection of a distinct cohort data feature, wherein processing the electronic communication data includes: generating by the plurality of distinct machine learning classifiers one or more cohort machine learning classification labels for each of the plurality of online users based on one or more distinct cohort data features of the extracted cohort data features; allowing the one or more cohort machine learning classification labels along with the extracted chat data features, as input, into the cohort grouping circuit; and identifying the at least one cohort grouping additionally based on the one or more cohort machine learning classification labels.

In one embodiment, identifying the at least one cohort grouping includes grouping into the subset of online users, by the cohort grouping circuit, online users having at least one common cohort machine learning classification label.

In one embodiment, the electronic communication server accesses the electronic communication data exchanged between the plurality of online users from one or more online third-party service providers including one or more of online networking services and email communication services.

In one embodiment, the system includes deploying the cohort networking mapping via an interface of an online networking service.

In one embodiment, an online method that enables intelligent online user classification and cohort detection within an electronic communications environment based on electronic communications data includes at an electronic communication networking service: an electronic communications server that accesses electronic communication data exchanged between a plurality of online users; an electronic communication processing circuit that processes the electronic communication data by: (i) extracting cohort data features from the electronic communication data; (ii) allowing the extracted cohort data features, as input, into a cohort grouping circuit; (iii) identifying, by the cohort grouping circuit, at least one cohort grouping comprising a subset of online users of the plurality of online users based on an output of the cohort grouping circuit; wherein the cohort grouping circuit uses the extracted cohort data features to generate a cohort network mapping that illustrates connections between the subset of online users defining the at least one cohort grouping.

In one embodiment, the method includes implementing a machine learning system comprising an ensemble of machine learning classifiers comprising a plurality of distinct machine learning classifiers, wherein each of the plurality of distinct machine learning classifiers is configured to generate a distinct classification label upon a detection of a distinct cohort data feature, wherein processing the electronic communication data includes: generating by the plurality of distinct machine learning classifiers one or more cohort machine learning classification labels for each of the plurality of online users based on one or more distinct cohort data features of the extracted cohort data features; allowing the one or more cohort machine learning classification labels along with the extracted chat data features, as input, into the cohort grouping circuit; and identifying the at least one cohort grouping additionally based on the one or more cohort machine learning classification labels.

In one embodiment, identifying the at least one cohort grouping includes grouping into the subset of online users, by the cohort grouping circuit, online users having at least one common cohort machine learning classification label.

In one embodiment, the electronic communication server accesses the electronic communication data exchanged between the plurality of online users from one or more online third-party service providers including one or more of online networking services and email communication services.

In one embodiment, the method includes deploying the cohort networking mapping via an interface of an online networking service.

In one embodiment, each of the online user of the subset of online users within the cohort network mapping is represented as a distinct node within a graphical representation of the cohort network mapping; the method further comprising: selecting a node within the graphical illustration of the cohort network mapping; and responsive to the selecting the node, automatically presenting via an interface of an online networking environment one or more options for establishing an electronic communication with the online user and/or routing an electronic message to the online user.

In one embodiment, each of the online user of the subset of online users within the cohort network mapping is represented as a distinct node within a graphical representation of the cohort network mapping; the method further including: identifying an interaction of user with a node within the graphical illustration of the cohort network mapping; in response to identifying the interaction, automatically deploying an electronic communication composition section within an interface of an online communication environment for generating and routing an electronic communication to the online user.

In one embodiment, the method includes receiving a search query; responsive to receiving the search query, automatically displaying the network mapping via an electronic communication interface of an online electronic communication environment.

In one embodiment, the search query comprises a name of an online user or a specific classification label assignable to online users.

In one embodiment, the method includes receiving a search query; responsive to receiving the search query, automatically displaying the network mapping via a networking interface of an online networking environment.

In one embodiment, the cohort networking mapping comprises a searchable graphical illustration; in response to receiving a search query for a specifically-named online user or a classification label of an online user, prominently identifying one or more nodes within the graphical illustration of the cohort network mapping that satisfy the search query, wherein the one or more nodes comprise one or more online users.

In one embodiment, the cohort network mapping includes an electronic communication path from a user that provided the search query to an online user or node within a graphical illustration of the cohort network mapping; and displaying the cohort network mapping includes prominently identifying the electronic communication path within the graphical illustration of the cohort network mapping.

In one embodiment, prominently identifying the one or more nodes within the graphical illustration of the cohort network mapping includes modifying a visual appearance of the one or more nodes thereby distinguishing the one or more nodes from other nodes of the graphical illustration of the cohort network mapping.

In one embodiment, prominently identifying the electronic communication path within the graphical illustration of the cohort network mapping includes modifying a visual appearance of the electronic communication path thereby distinguishing the electronic communication path from other electronic communication paths of the graphical illustration of the cohort network mapping.

In one embodiment, an online system that enables intelligent user classification and cohort detection within an email environment based on email communication data includes: an electronic communications server that accesses email communication data exchanged between a plurality of online users; an email communication processing circuit that processes the email communication data by: (i) extracting cohort data features from the email communication data; (ii) allowing the extracted cohort data features, as input, into a cohort grouping circuit; (iii) identifying, by the cohort grouping circuit, at least one cohort grouping comprising a subset of online users of the plurality of online users based on an output of the cohort grouping circuit; wherein the cohort grouping circuit uses the extracted cohort data features to generate a cohort network mapping that illustrates connections between the subset of online users defining the at least one cohort grouping.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

Overview

As discussed in the above sections, the complications of interfacing and managing electronic communications are varied and great in number. Specifically, email communication users are inundated with countless electronic messages and the existing electronic communication platforms fail to provide useful electronic communication interfaces and electronic communication tools to address the several technical deficiencies thereof.

However, several of the embodiments of the present application, enable enhanced electronic communications by users providing an intelligent electronic communications and messaging platform that harvests useful and intelligent insights from electronic communication histories of the users of the intelligent electronic communication and messaging platform or any suitable communication network, including, but not limited to, professional communication networks, social communication networks, business communication networks, and/or the like.

As an example, a technical benefit and/or advantage embodied within the one or more of the several embodiments of the present application includes an ability of the intelligent electronic communication platform to detect, classify, and/or suggest cohorts of electronic communication users based on advanced machine learning processing and the like of the electronic communication histories of the electronic communication users operating on or using one or more aspects of the described intelligent platform and/or similar electronics communications network. The detected and/or suggested cohort groups enable intelligent and faster processing, prioritizing, disposing, and electronic communication routing with respect to each member of the respective cohort. That is, using the cohort groups, the intelligent electronic communication platform can automatically implement one or more advanced electronic processing techniques to inbound and outbound electronic communications that reduce or ameliorate the technical inefficiencies and technical problems in handling electronic communications as well as provide electronic communication tools (such as tools for interfacing with the detected cohort grouping). Additionally, specific electronic communication users may function to use the detected cohort groups in electronic communication routing and planning to members within the cohort and/or other electronic communication users that may be external to the cohort group but nevertheless connected to the cohort group based on evaluations of their electronic communication histories.

### 1. System for Cluster Detection Based on Electronic Communication Data

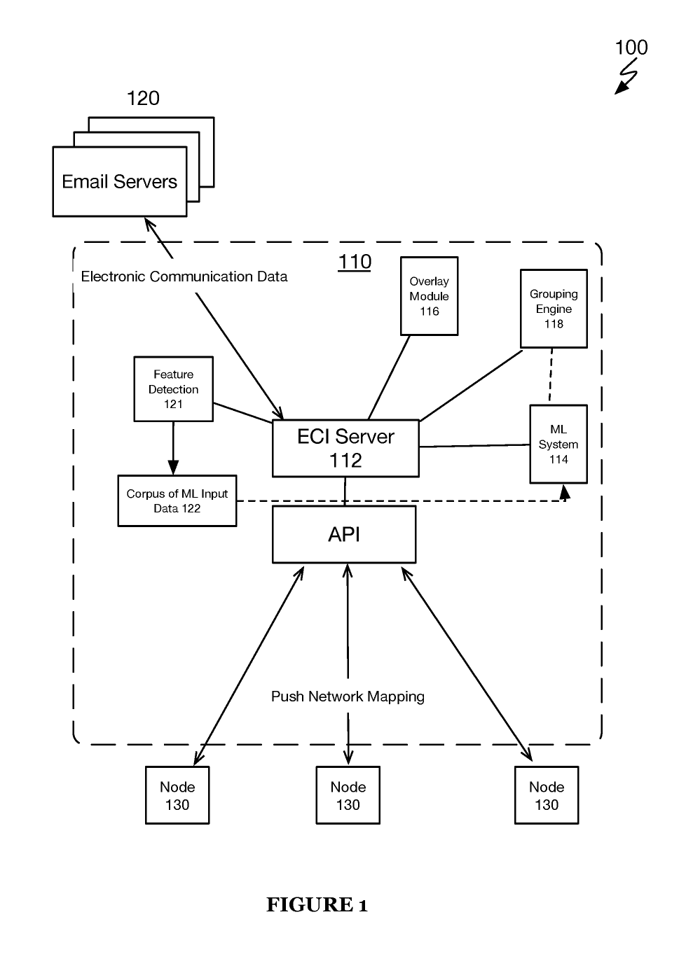

As shown in FIG. 1, a system 100 for cohort detection within a plurality of communication nodes of an electronic communication environment includes an electronic communication platform (service) 110, a plurality of mail servers 120, and a plurality of communication nodes 130. The electronic communication platform no may include an electronic communication integration server 112, a machine learning system 114, an overlay module 116, and a grouping engine 118.

The system 100 functions to detect, classify, and/or define groupings of communication nodes sharing one or more commonalities in features based on electronic communications exchanged between the communication nodes. A communication node as referred to herein may refer to an electronic communication user and/or a computing system that is operated or used by an electronic communication user. Thus, a communication node may be defined by a user profile, a user account, and/or user dataset of a user involved in exchanges of electronic communication in any suitable electronic communications environment. Accordingly, the system 100 functions to evaluate electronic communications (data) exchanged and/or shared between a plurality of communication nodes (thousands to millions of communication nodes) to determine whether subsets of the plurality of communication nodes should be affiliated or grouped as cohorts. A cohort as referred to herein may refer or relate to a grouping of communication nodes (or users operating in an electronic communications environment) that share one or more attributes, characteristics, and/or commonalities based on one or more common or related machine learning classification labels that are generated or identified for each of the communication nodes in the cohort. In a variation, a cohort may additionally or alternatively refer to a grouping of communication nodes that share one or more attributes, characteristics, and/or commonalities that satisfy or exceed a predetermined threshold, such as a minimum shared commonality threshold or a minimum shared attribute threshold. Once a cohort of communication nodes have been identified by the system 100, the system 100 may additionally generate networking mappings (e.g., social networking maps, professional networking maps, affinity networking maps, etc.) of the communication nodes of the identified cohort group that establishes communication (and/or relationship) connections pairs of communication nodes. The system 100 may function to use the network mappings of communication nodes to generate user interface tools that may be used to expedite communications thereby improve an electronic communication environment.

The electronic communication integration server 112 of the platform 110 preferably functions to extract electronic communications, such as email communications, chat messaging communications, social networking communications, and/or professional networking communications from the plurality mail servers 120 (e.g., messaging servers, electronics communications servers, etc.). In many embodiments, the electronic communication integration server 112 functions as a proxy server (or API server) capable of interfacing with a plurality of email servers for directing email communications to and from the plurality of email servers to corresponding user email accounts and client devices. Additionally, the electronic communication integration server 112 may additionally interface with any type of electronic communication server or platform including chat communication servers, text messaging communication servers, social networking communication servers, and the like. The email communications extracted from the mail servers 120 may be associated with one or more user accounts or one or more user devices configured to transmit and receive electronic mail communication using the electronic communication integration platform 110.

The electronic communication integration server 112 may extract email communications on a periodic or continuous basis (e.g., in real-time or near real-time). Additionally, or alternatively, the electronic communication integration server 112 may extract email communications based on a request by a user client device or an indication by the plurality of mail servers 120 that email communications are available for extraction. Additionally, or alternatively, the electronic communication integration server 112 may automatically receive email communications from the plurality of mail servers 120 without expressly making an extraction request or the like. The automatic transmission of email communications from the plurality of mail servers 120 to the electronic communication integration server 112 may be based on a predetermined or dynamic schedule negotiated between the electronic communication integration server 112 and the plurality of mail servers 120.

Additionally, the electronic communication integration server 112 in cooperation with the overlay module 116 functions to generate overlay data for an email communication and, functions to store the generated overlay data for the email communication. Preferably, the electronic communication integration server 112 functions to permanently store the overlay data so long as the associated email communication persists within the mail server (e.g., mail servers 120).

Upon receipt by the electronic communication integration server 112 of an email communication request (e.g., request for email list of a recipient user) from one or more of the plurality of communication nodes 130, the electronic communication integration server 112 functions to pull or extract email communications from the plurality of mail servers 120. Specifically, the email communication request from the communication nodes 130 may include user identification information that allows the electronic communication integration server 112 to correspond the user identification information to an email communication account at the one or more of the plurality of mail servers 120.

Once the electronic communication integration server 112 receives the email communications from the plurality of mail servers 120, the electronic communication integration server 112 functions to generate overlay data for the email communications and join or integrate the generated overlay data to the email communications thereby generating integrated email communications. Following, the electronic communication integration server 112 functions transmits the integrated email communication via a communication network to a communication node 130 of the recipient user requesting the email communications.

In a preferred embodiment, the electronic communication integration server 112 may function to generally monitor and collect or analyze the electronic communications exchanged between the plurality of communication nodes 130.

The electronic communication integration server 112 may be implemented via one or more computing servers. Additionally, or alternatively, the electronic communication integration server 112 may be implemented via a distributed computing network (e.g., the cloud). It shall be noted that while, the electronic communication integration server 112 is preferably implemented and maintained by a separate entity different from an entity maintaining the plurality of mails servers 120, in some embodiments, the electronic communication integration server 112 and mail servers 120 may be maintained or implemented by a same entity or may be combined into a single computing server.

The machine learning system 114 of the electronic communication platform 110 may function to detect cohorts of communication nodes and further, classify the cohorts of communication nodes with labels. The machine learning system 114 may implement a trained machine learning model or an ensemble of trained machine learning models that function to use as machine learning input feature vectors extracted from any type or kind of electronic communication data and/or from communication node data of the system 100 to identify cohort groupings or related clusters of communication nodes as well as suitable classifications (e.g., a type of cohort grouping). The machine learning system 114 may detect cohorts of communication nodes based on one or more affinity factors (or cohort factors). An affinity factor may include any characteristic or feature of a communication node and/or electronic communications exchanged between communication nodes that indicates a potential similarity between, at least, two communication nodes. For example, several affinity factors relating to characteristics or features of the communication nodes may include demographic data, career data, user profile data, employer data, and the like of a user associated with a communication node, a location of the communication node, and the like. Examples of affinity factors relating to characteristics or features of the electronic communications exchanged between communication nodes include subject matter of a communication, key terms used in the content of a communication, a frequency of communication, a length of communication, communication times, members involved in an electronic communication, and the like.

Additionally, the machine learning system 114 may function to train one or more machine learning models via a machine learning training engine. The machine learning training engine may include a variety of selectable training algorithms, hyperparameters, training data, and the like that may be used in one or more machine learning training processes. Additionally, the machine learning system 114 may function to identify or classify features of the accessed or collected electronic communication data. The machine learning system 114 may be implemented by one or more computing servers having one or more computer processors (e.g., graphics process units (GPU), central processing units (CPUs, MCUs, etc.), or a combination of web servers and private servers) that may function to implement one or more ensembles of machine learning models. The ensemble of machine learning models may include multiple machine learning models that work together to identify communication node groupings and classify features of the node groupings. The machine learning system 114 may function to communicate via one or more wired or wireless communication networks. The machine learning system 114 may additionally utilize input from various other data sources (e.g., outputs of system 100, system 100 derived knowledge data, external entity-maintained data, etc.) to continuously improve or accurately tune weightings associated with features of the one or more of the machine learning models of the system 100.

The machine learning system 114 may employ any suitable machine learning including one or more of: supervised learning (e.g., using logistic regression, back propagation neural networks, random forests, decision trees, etc.), unsupervised learning (e.g., using an Apriori algorithm, k-means clustering, etc.), semi-supervised learning, reinforcement learning (e.g., using a Q-learning algorithm, temporal difference learning, etc.), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) can be used in detecting cohorts of communication nodes and/or other data relevant to system 100.

The grouping engine 118 includes a grouping server that is in operable communication with the machine learning system 114 and a grouping database. The grouping engine 118 may enable cohort detection functionality that enables the grouping server to generate or suggest one or more groups or individuals based on outputs (e.g., classification labels) of the machine learning system 114. Additionally, or alternatively, the cohort detection functionality may be implemented to identify any type of appropriate affiliation based on identified electronic communications. Some example affiliations include, but should not be limited to, any associate of a recipient of the communication, one or more known or prospective collaborators of the recipient, one or more teams (e.g., baseball team, legal team, marketing team, etc.) associated with the recipient, and the like. Specifically, in some embodiments, the grouping engine 118 may function to generate or receive an analysis of an inbound email communication and based on the analysis, determine one or more cohorts including one or more persons and/or groups that a user should evaluate for a potential chat communication session, as described in U.S. patent application Ser. No. 15/995,865, which is incorporated herein by this reference in its entirety. These identified one or more persons and/or groups may be associated or linked to a recipient user of an email or electronic communication as a cohort, an associate, a team member, and/or a collaborator.

The plurality of mail servers 120 may include a plurality of mail servers or electronic communication servers maintained by a plurality of disparate entities (e.g., online networking services, email service providers, and/or the like). The mail servers 120 may include outgoing mail servers, such as Simple Mail Transfer Protocol (SMTP) servers, and incoming mail servers, such as Post Office Protocol (POP₃), and Internet Message Access Protocol (IMAP). The plurality of mail servers 120 should not be limited to the example mail servers described above and can be encompassed by any suitable mail server or electronic communication server.

The plurality of communication nodes 130 may include one or more user client devices connected over a network (e.g., the Internet) to the electronic communication integration platform 110. The plurality of communication nodes 130 may include any type of device capable of receiving and presenting a content of an electronic communication (e.g., an inbound email communication to a user). For instance, the plurality of communication nodes 130 may include, but are not limited to, mobile computing devices (e.g., mobile phones, tablets, etc.), desktop computers or laptops, virtual and/or personal assistant devices (e.g., Alexa, Google Home, Cortana, Jarvis, etc.), chatbots or workbots, etc. A communication node may additionally include an electronic communication user that functions to operate or use the one or more computing devices of a communication node. Thus, in some embodiments, the communication may be a combination of an electronic communication user and a computing device that may be used for implementing electronic communications. An intelligent personal assistant devices (e.g., Alexa, etc.) may be any type of device capable of touchless interaction with a user to performing one or more tasks or operations including providing data or information and/or controlling one or more other devices (e.g., computers, email interfaces, etc.). Thus, an intelligent personal assistant may be used by a user to perform any portions of the methods described herein, including the steps and processes of method 200 and/or method 300, described below. Additionally, a chatbot or a workbot may include any type of program (e.g., slack bot, etc.) implemented by one or more devices that may be used to interact with a user using any type of input method (e.g., verbally, textually, etc.). The chatbot or workbot may be embedded or otherwise placed in operable communication and/or control of a communication node and thus, capable of performing any process or task of a communication node including, but not limited to, acquiring and providing information (e.g., email data) and performing one or more control operations (e.g., triggering a communication composition, chat request or chat session etc.). The plurality of communication nodes 130 may be operable to implement an email client application or email browser that enable the communication nodes 130 to receive, interact with, and transmit email communications.

It shall be noted that the cohort detection and/or electronic communication/networking service users may be enhanced or be used to enhanced the one or more inventions described in U.S. patent application No. 62/581,243 and U.S. Patent Application No. 62/612,809, which are both incorporated herein in their entireties by this reference.

### 2. Method for Cluster Detection Based on Electronic Communication Data

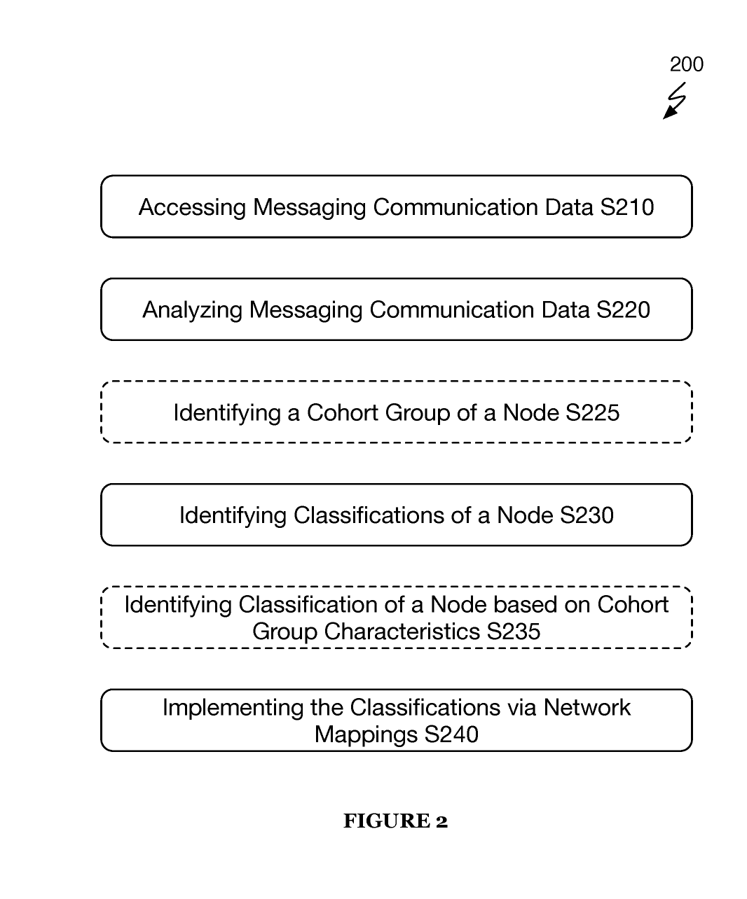

As shown in FIG. 2, a method 200 for identifying cohorts includes accessing messaging communication data S210, analyzing the accessed messaging communication data S220, identifying cohort communication nodes S230, generating a plurality of network mappings based on the cohort communication nodes S240, and implementing the plurality of network mappings within an electronic communications environment S250. The method 200 optionally includes classifying each of the plurality of network mappings S245.

The method 200 functions to enable a detection of one or more cohorts of communication nodes. The communication nodes of the method 200 may communicate with each other in any manner of electronic communication, including but not limited to, via email communication, via (short, text, etc.) messaging, chat messaging, messaging via social media interfaces, and the like. The method 200 functions to periodically analyze communication connections between each of the communication nodes to thereby identify characteristics and features of these communication communications as well as characteristics and features of the communication data (e.g., communication content) transmitted and/or exchanged via the communication connections. The method 200 may function to use the characteristics and/or features of the communication connections together with characteristics and/or features of the communication data transmitted via the communication connections to identify one or more groups or cohorts of communication nodes having commonalities in the features of their communication connections and/or within the communication data transmitted via the communication connections.

It shall be noted that, while the method 200 may preferably detect cohorts within communication nodes, the method 200 (and variants thereof) may function to detect cohorts of any type and in any suitable manner, including cohorts of people, devices, and the like that operate outside a system implementing the method 200.

S210, which includes accessing messaging communication data S210, functions to access or collect messaging communication data generated across and/or between a plurality of communication nodes. In a preferred embodiment, collected messaging communication data S210 includes messaging communication data transmitted between pairs of communication nodes in which the communication nodes in defining the pair may be in direct communication with each other. In such embodiment, the collected communication data comprises communication data transmitted between the pair of communication nodes in which the communication data may be intended for at least one communication node of the pair of communication nodes. For example, a first communication node transmitting an email message to a second communication node defines a pair of communication nodes and the email message (messaging communication data) transmitted between the first and second communication nodes (pair) may be collected by the method 200 (S210) as communication data.

Additionally, or alternatively, S210 may function to collect messaging communication data between any number of communication nodes. In some embodiments, S210 functions to collecting messaging communication data originating from and being received by a plurality of communication nodes interacting or communicating with each other during a same messaging communication session or using a common messaging communication chain. In such embodiments, one or more communication nodes may transmit or initiate a messaging communication (chain or session), such as a chat message, social media message or post, a social networking message or post, or an email message with several communication nodes copied or tied. S210, in such instance, may function to access or collect messaging communication data deriving from the interactions of any or all the communication nodes with the messaging communication.

Accordingly, in some embodiments, S210 may function to collect electronic communications data involving one or more online users from one or more third-party service providers including one or more of online networking services and one or more email communication services or the like.

S210 may, additionally or alternatively, collect communication node data including characteristics and/or attributes about each of the communication nodes. The communication node data may include data about one or more user accounts associated with the communication node, one or more user profiles associated with the communication node, a communication node type (e.g., mobile device, desktop computer, etc.), a virtual location (e.g., IP address, etc.) and/or physical location (e.g., geographic location) of the communication node, electronic communication service provider (e.g., Gmail, Outlook, Slack, LinkedIn, Chat Messaging Services, etc.), and the like. S210 may collect any suitable characteristic or feature data regarding a communication node. As mentioned, the communication node data may include data identifying user accounts and/or user profiles (e.g., user's name, user demographic information, user position/job title, etc.) associated with each of the communication nodes. User account data and/or user profile data may also be determined by S210 based on the content of the messaging communication data exchanged between nodes. In such instances, meta data and/or contents (e.g., signature line, key terms, etc.) of the messaging communication data may be used to specifically identify user account data and/or user profile data. The identified user data may be packaged by S220 as user identification/characterization input that functions to identify or characterize the one or more persons or entities involved in exchanging messaging communication data at the communication nodes.

The communication nodes may include a plurality of client devices and/or client applications operating in an electronic communication environment. The electronic communication environment preferably includes a communication network that is defined by one or more electronic communication servers that may be accessed by the plurality of client devices and/or applications for purposes of exchanging electronic messages with various clients and/or servers within the communication network. The plurality of electronic communications servers may include electronic mail (email) servers, chat messaging (e.g., online instant messaging) servers, and the like. In some instances, each of the one or more electronic communication servers may provide a combination of services, such as email communication services and chat messaging services to any connected client device or client application.

Additionally, or alternatively, the plurality of electronic communication servers may function to store the electronic messaging communication data transmitted between the communication nodes (e.g., clients) connected thereto. S210 may then function to access or collect the electronic messaging communication data stored by the one or more electronic messaging communication servers. Additionally, or alternatively, S210 may function to access and/or use the electronic messaging communication stored by the plurality of electronic communication servers preferably without separately copying and storing the electronic communication data.

S220, which includes analyzing the collected messaging communication data, functions to analyze characteristics of the collected messaging communication data. S220 may function to implement any suitable data analytical technique to identify and/or measure various characteristics of the collected messaging communication data.

In a preferred embodiment, S220 functions to analyze the characteristics of the accessed messaging communication data to identify or generate one or more communication metrics such that communication propensities and/or affinities of the one or more associated communication nodes may be identified (see S230). In such preferred embodiment, S220 may function to identify a frequency of which communications are exchanged (i.e., a communication frequency metric) between two or more communication nodes. For example, S220 may analyze the corpus of collected messaging communication data and identify a frequency of communication between two nodes of three exchanged communications between a pair of communication nodes per day. S220 may determine a frequency based on any measurable period including, but not limited to, hourly, daily, weekly, monthly periods, and the like.

Additionally, or alternatively, S220 may function to perform content analysis of the messaging communication data. S220 may function to scan content of the messaging communication data to identify a subject matter or topic of the messaging communication. Accordingly, in some embodiments, S220 may function to parse terms, characters, symbols, media, and the like from a content of the messaging communication data. In one variation, S220 may function to extract various feature vectors using a cohort feature extractor (e.g., a deep machine learning model or any suitable high-level feature extractor). The parsed data or feature vectors from the messaging communication data may be packaged by S220, as input data, into a machine learning model (system) or other predictive or analytics system that may function to use the packaged input data to estimate a subject matter of the messaging communication data, as discussed in S230.

S220 may, additionally or alternatively, function to identify further characteristics and/or features of the messaging communication data including, but limited to, length data relating to a length of the communication and/or a length of an overall communication exchange associated with the messaging communication data, response time(s) (e.g., amount of time between a transmission of the communication and a response or reply to the communication by a recipient) associated with the messaging communication data, communication transmission times (e.g., a time of day at which the communications are transmitted by a node), and the like. These additional characteristics, communication metrics, and/or features measured or identified by S220 may similarly be packaged as additional input data, as discussed in S230, into an analytical system for detecting cohort groupings.

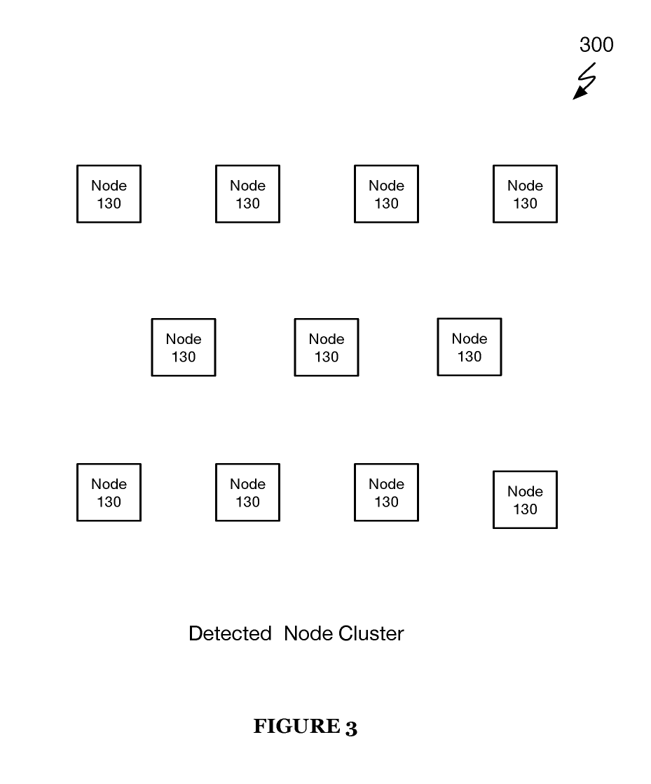

S230, which includes identifying cohort communication nodes, may function to use as input one or more characteristics and/or features extracted from the accessed messaging communication data and preferably, the analysis results of the collected messaging communication data to determine clusters of related communication nodes, as shown in FIG. 3. Additionally, or alternatively, S230 may function to use as input one or more characteristics and/or features extracted from each of the communication nodes, per se, to determine clusters of related communication nodes. Using input derived at least from S210 and S220, S230 preferably functions to identify clusters of communication nodes having a tendency or propensity for communication or interaction with each other. A determination of a propensity or tendency for communication may be established in S230 in accordance with any feature or characteristic (or combination of features or characteristics) of the communication nodes and/or the messaging communications exchanged between the subject communication nodes.

In a preferred embodiment, S230 may function to implement a machine learning system comprising one or more machine learning models and/or an ensemble of machine learning models that function to identify clusters of communication nodes. In some embodiments, S230 implements an ensemble of machine learning models comprising a plurality of distinct learning models with each of the distinct machine learning models functioning to estimate or identify a cluster of related communication nodes based on a characteristic and/or feature of the messaging communication data and/or a characteristic and/or feature of the communication nodes. For instance, an ensemble of machine learning models may include a first trained machine learning model that identifies clusters based on a group of communication nodes having a common geographic location or being in geographic proximity to each other (e.g., features including IP addresses indicating that several communication nodes communicating with each other may be located in the Ann Arbor, Mich. area). Further with respect to such instance, the ensemble of machine learning models may include a second trained machine learning model that functions to identify clusters based on a frequency of messaging communications exchanged between a group of communication nodes (e.g., each of the communication nodes within the identified group tend to communication with each other daily). It shall be noted that an ensemble of machine learning models implemented in S230 may include any number of disparate machine learning models beyond the example first and second machine learning models described above.

In one implementation, S230 may function to implement a plurality of distinct machine learning classification models that may operate in concert as an ensemble of machine learning classifiers. In such implementation, each of the plurality of distinct machine learning classification models may function to output a distinct machine learning classification label comprising a predicted cohort type or label based on an input of one or more features extracted from the electronic communications data or features extracted from the communication nodes. Accordingly, each of the distinct machine learning classification labels may be mapped to a specific or predetermined cohort type of a plurality of cohort types. Once a distinct machine learning classification label is generated, S230 may function to assign or map the classification label to the one or more communication nodes associated with the electronic communication data from which the input features were extracted.

It shall be noted that S230 may function to generate multiple distinct machine learning classification labels for a given communication node and thus, S230 may function to assign the one communication node to multiple cohort groups or cohort types based on the distinct machine learning classification labels assigned to the communication node.

Additionally, or alternatively, S230 may function to implement any cluster analysis, statistical analysis, and/or rule-based heuristics for identifying clusters of communication nodes. For instance, S230 may implement K-means algorithm clustering, hierarchical clustering, biclustering, clique clustering, fuzzy clustering, and any suitable clustering or grouping technique. For instance, S230 may implement fuzzy clustering in the instances in which a communication node may be clustered into more than one disparate clusters of communication nodes.

In one implementation, S230 may function to implement a cohort grouping circuit (implemented by one or more processors and/or one or more computing servers) that may function to identify or generate cohort groupings comprising a plurality of communication nodes (e.g., a plurality of online users) based on one or more distinct machine learning classification labels assigned to each of the plurality of communication nodes. The cohort grouping circuit may function to implement any suitable clustering or grouping module that groups communication nodes together when each of the communication nodes defining the group share at least one common classification label and/or one common (extracted) feature.

Further, in some embodiments, S230 may function to use ego networks and data, insights, and comprehensions derived from the relationships of ego networks to suggest, detect, and/or generate cohort groups.

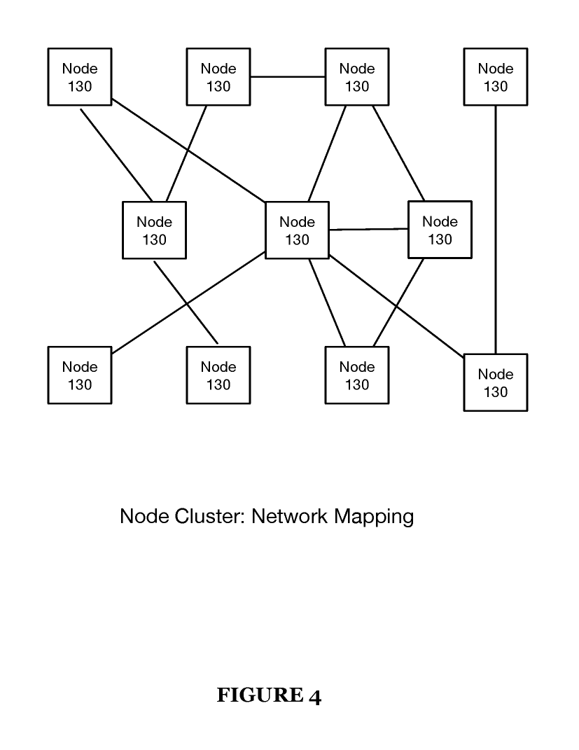

S240, which includes generating a mapping of the identified cohort groupings, functions to generate one or more networking mappings of the communication nodes of an identified cohort grouping (e.g., cohort cluster), as illustrated in FIG. 4. The one or more networking mappings of the communication nodes may include connections between communications nodes that are direct connections that, in some embodiments, indicate a relatively stronger connection than indirect connections (e.g., secondary connections, tertiary connections, and the like). Accordingly, the one or more networking mappings, when viewed from the perspective of one or more principal (or subject) communication nodes, may include principal communication nodes that have direct communication connections with a plurality of other (non-principal) communication nodes (e.g., P→A, P→C, P→E, etc.). The principal communication node may include or relate to a communication node that initiates a generation or identification of a cohort group. From a direct communication connection, the networking mappings of the communication nodes of a cohort group or cluster may be extended to include one or more secondary communication connections (relative to the direct communication connection). For example, the example P→A direct connection may be extended to include a secondary (indirect) connection, A→E (resulting in P→A→E) mapping and/or the example P→C direct connection may be extended to include a secondary connection C→F (resulting in P→C→F mapping). In P→C→F mapping example, in which the networking mappings are extended to include secondary connections, the terminal communication node at the secondary connection may have an attenuated communication connection to the principal node, P, (which may indicate that F node communications more directly (or frequently) with the C node that the P node) but may nevertheless be included in the networking mapping of the communication nodes because the communication nodes share an underlying common characteristic or feature (e.g., each of the P, C, and F nodes are geographically located in a common area and/or the P, C, and F nodes are associated with users accounts of users working in a same field).

It shall be understood that the principal node of a network mapping or cluster of communication node may be any communication node in a cluster of communication nodes. Thus, any communication node within a cluster may be selected (for illustrative purposes) to identify direct communication connections, secondary (or indirect) communication connections, tertiary communication connections, and the like. Additionally, the perspective of a selected principle node may be used to identify direct and/or indirect communication connections with respect to the principal node. Thus, a designation of a principal communication node of a cluster of communication nodes may allow for a configuration of the networking mapping for such cluster to focus around and/or based on a perspective of the identified principal node.

Additionally, or alternatively, a designation of a non-principal communication node of a cluster of communication nodes may allow for a configuration of the network mapping for a cluster to focus around and/or based on perspectives of the selected non-principal node (e.g., typically a member of the cohort group that may not be a principal user of the networking mapping).

Accordingly, the generated networking mappings may be generated in S240 based on any one or combination of common characteristics of the communication nodes and/or characteristics or features of the messaging communications exchanged between the nodes.

Optionally, S245, which includes classifying each of the plurality of network mappings, may function to generate or estimate a label for each of the plurality of network mappings based on a predominate characteristic and/or feature (e.g., predominate affinity factor) of the cluster of communication nodes used in defining the network mappings. In some embodiments, S245 functions to classify each of the plurality of network mappings using a same or similar machine learning model used in generating the cluster of communication nodes used in defining the networking mappings. As a few non-limiting examples, S245 may function to classify a network mapping as a cohort of “close friends”, a cohort of “investors in Ann Arbor, Mich.”, a cohort of users who talk about patent law in the Chicago area, a cohort of influential people in a specific company, and the like.

S250, which includes implementing the plurality of network mappings, functions to implement or deploy the plurality of network mappings into one or more electronic communication environments or electronic networking services.

In a preferred embodiment, S250 may function to deploy or present the plurality of network mappings to an electronic mail (email) environment associated with each of the communication nodes within a respective network mapping. In such preferred embodiment, a network mapping may be illustrated as a graphical interface component showing each of the plurality of communication nodes of the network mapping and the communication connections existing between the plurality of communication nodes. The illustration of the network mapping may be presented directly via email interfaces associated with each of the plurality of communication nodes. In this way, users associated with the communication nodes may visually inspect and/or interact with the network mapping.

Additionally, or alternatively, S250 may function to deploy or export the network mappings via any suitable device, medium, and/or user interfacing means (as described in section I. and the like) including, but not limited to, one or more software or mobile applications, chat/work (or any virtual bot or assistant), voice outputs and applications, and the like.

Additionally, or alternatively, when presented via the electronic communication environment (e.g., email interface and the like), components of the network mappings may be interactive and/or selectable to a user thereby enabling the user to expedite electronic communications and improve overall interactions within electronic communication environment. For instance, a user may be capable of selecting a communication node within a graphical illustration of the network mapping in order to initiate a communication with a user associated with the communication node. In such instance, the user may hover or use a selection component to interact with the network mapping in order to trigger an implementation of a communication interface component (e.g., email composition section, a chat communication section, etc.) that enables the user to quickly and efficiently establish a communication session and/or generate a communication to another user associated with a selected communication node within the presented network mapping.

Additionally, or alternatively, S250 may function to trigger the presentation and/or modification of a network mapping in response to one or more actions of a user that utilizes an electronic communication interface. In one implementation, S250 functions to automatically display a network mapping within an electronic communication environment based on a search query provided with the electronic communication interface. In such implementation, a user may input a query comprising a prospective recipient user's name or prospective user account information of the prospective recipient to identify any direct or indirect communication connections or communication nodes that may share a direct (secondary, or tertiary connection) with the prospective recipient user to which the user. The processing of the query by the electronic communication interface may trigger or cause an automatic display of the network mapping together with indications within the network mapping of a communication path to the prospective recipient of an electronic communication from the user.

In a second implementation, S250 may automatically display and/or modify a display of a network mapping based on a user's interaction with a communication composition component (e.g., email composition section, text messaging section, chat messaging section, etc.). In such second implementation, an input of a subject matter or topic within a section (e.g., RE line) of the communication composition component may trigger a display of the network mapping together with an indication of one or more communication nodes that may be relevant to the potential communication. Additionally, or alternatively, a user's interaction to provide a communication destination and/or recipient may trigger a display of a network mapping within the electronic communication interface together with an indication of one or more communication nodes that may be relevant for the prospective communication.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the claims.

What is claimed is:

1. An online system that enables intelligent user classification and cohort detection within an electronic communications environment based on electronic communications data, the online system comprising:
an electronic communications server that accesses electronic communication data exchanged between a plurality of online users;
an electronic communication processing circuit that processes the electronic communication data by:
(i) extracting cohort data features from the electronic communication data;
(ii) allowing the extracted cohort data features, as input, into a cohort grouping circuit;
(iii) identifying, by the cohort grouping circuit, at least one cohort grouping comprising a subset of online users of the plurality of online users based on an output of the cohort grouping circuit;
wherein the cohort grouping circuit uses the extracted cohort data features to generate a cohort network mapping that illustrates connections between the subset of online users defining the at least one cohort grouping.

2. The system according to claim 1, further comprising:
a machine learning system comprising an ensemble of machine learning classifiers comprising a plurality of distinct machine learning classifiers, wherein each of the plurality of distinct machine learning classifiers is configured to generate a distinct classification label upon a detection of a distinct cohort data feature,
wherein processing the electronic communication data includes:
generating by the plurality of distinct machine learning classifiers one or more cohort machine learning classification labels for each of the plurality of online users based on one or more distinct cohort data features of the extracted cohort data features;
allowing the one or more cohort machine learning classification labels along with the extracted archetype data features, as input, into the cohort grouping circuit; and
identifying the at least one cohort grouping additionally based on the one or more cohort machine learning classification labels.

3. The system according to claim 2, wherein
identifying the at least one cohort grouping includes grouping into the subset of online users, by the cohort grouping circuit, online users having at least one common cohort machine learning classification label.

4. The system according to claim 1, wherein
the electronic communication server accesses the electronic communication data exchanged between the plurality of online users from one or more online third-party service providers including one or more of online networking services and email communication services.

5. The system according to claim 1, further comprising:
deploying the cohort network mapping via an interface of an online networking service.

6. An online method that enables intelligent online user classification and cohort detection within an electronic communications environment based on electronic communications data, the online method comprising:
at an electronic communication networking service that is implemented by one or more networked computing servers:
accessing electronic communication data exchanged between a plurality of online users;
processing the electronic communication data by:
(i) extracting cohort data features from the electronic communication data;
(ii) allowing the extracted cohort data features, as input, into a cohort grouping circuit;
(iii) identifying, by the cohort grouping circuit, at least one cohort grouping comprising a subset of online users of the plurality of online users based on an output of the cohort grouping circuit;
wherein the cohort grouping circuit uses the extracted cohort data features to generate a cohort network mapping that illustrates connections between the subset of online users defining the at least one cohort grouping.

7. The method according to claim 6, further comprising:
implementing a machine learning system comprising an ensemble of machine learning classifiers comprising a plurality of distinct machine learning classifiers, wherein each of the plurality of distinct machine learning classifiers is configured to generate a distinct classification label upon a detection of a distinct cohort data feature,
wherein processing the electronic communication data includes:
generating by the plurality of distinct machine learning classifiers one or more cohort machine learning classification labels for each of the plurality of online users based on one or more distinct cohort data features of the extracted cohort data features;
allowing the one or more cohort machine learning classification labels along with the extracted chat data features, as input, into the cohort grouping circuit; and
identifying the at least one cohort grouping additionally based on the one or more cohort machine learning classification labels.

8. The method according to claim 7, wherein
identifying the at least one cohort grouping includes grouping into the subset of online users, by the cohort grouping circuit, online users having at least one common cohort machine learning classification label.

9. The method according to claim 6, wherein
the electronic communication server accesses the electronic communication data exchanged between the plurality of online users from one or more online third-party service providers including one or more of online networking services and email communication services.

10. The method according to claim 6, further comprising:
deploying the cohort network mapping via an interface of an online networking service.

11. The method according to claim 6, wherein
each of the online user of the subset of online users within the cohort network mapping is represented as a distinct node within a graphical representation of the cohort network mapping;
the method further comprising:
selecting a node within the graphical illustration of the cohort network mapping; and
responsive to the selecting the node, automatically presenting via an interface of an online networking environment one or more options for establishing an electronic communication with the online user and/or routing an electronic message to the online user.

12. The method according to claim 6, wherein
each of the online user of the subset of online users within the cohort network mapping is represented as a distinct node within a graphical representation of the cohort network mapping;
the method further comprising:
identifying an interaction of user with a node within the graphical illustration of the cohort network mapping;
in response to identifying the interaction, automatically deploying an electronic communication composition section within an interface of an online communication environment for generating and routing an electronic communication to the online user.

13. The method according to claim 6, further comprising:
receiving a search query;
responsive to receiving the search query, automatically displaying the cohort network mapping via an electronic communication interface of an online electronic communication environment.

14. The method according to claim 13, wherein
the search query comprises a name of an online user or a specific classification label assignable to online users.

15. The method according to claim 6, further comprising:
receiving a search query;
responsive to receiving the search query, automatically displaying the cohort network mapping via a networking interface of an online networking environment.

16. The method according to claim 6, wherein
the cohort network mapping comprises a searchable graphical illustration;
in response to receiving a search query for a specifically-named online user or a classification label of an online user, prominently identifying one or more nodes within the graphical illustration of the cohort network mapping that satisfy the search query, wherein the one or more nodes comprise one or more online users.

17. The method according to claim 16, wherein
the cohort network mapping includes an electronic communication path from a user that provided the search query to an online user or node within a graphical illustration of the cohort network mapping; and
displaying the cohort network mapping includes prominently identifying the electronic communication path within the graphical illustration of the cohort network mapping.

18. The method according to claim 16, wherein
prominently identifying the one or more nodes within the graphical illustration of the cohort network mapping includes modifying a visual appearance of the one or more nodes thereby distinguishing the one or more nodes from other nodes of the graphical illustration of the cohort network mapping.

19. The method according to claim 17, wherein
prominently identifying the electronic communication path within the graphical illustration of the cohort network mapping includes modifying a visual appearance of the electronic communication path thereby distinguishing the electronic communication path from other electronic communication paths of the graphical illustration of the cohort network mapping.

20. An online system that enables intelligent user classification and cohort detection within an email environment based on email communication data, the online system comprising:
an electronic communications server that accesses email communication data exchanged between a plurality of online users;
an email communication processing circuit that processes the email communication data by:
(i) extracting cohort data features from the email communication data;
(ii) allowing the extracted cohort data features, as input, into a cohort grouping circuit;
(iii) identifying, by the cohort grouping circuit, at least one cohort grouping comprising a subset of online users of the plurality of online users based on an output of the cohort grouping circuit;
wherein the cohort grouping circuit uses the extracted cohort data features to generate a cohort network mapping that illustrates connections between the subset of online users defining the at least one cohort grouping.
